(19) United States
(12) Patent Application Publication
(10) Pub. No.: US 2025/0283990 A1
(43) Pub. Date: Sep. 11, 2025

(54) DOMED THERMOSTAT LENS ASSEMBLY

(71) Applicant: Google LLC, Mountain View, CA (US)

(72) Inventors: Justin Wodrich, Los Gatos, CA (US); William Dong, Orange, CA (US); Adrian Shanov, San Francisco, CA (US); Dongkyu Lee, Castro Valley, CA (US); Sung Kyun Bai, San Jose, CA (US); Phan Thao Benno Dang, San Francisco, CA (US); Tyler Wilson, San Diego, CA (US); Maj Isabelle Olsson, Sunnyvale, CA (US); Eun Hee Jo, San Jose, CA (US)

(73) Assignee: Google LLC, Mountain View, CA (US)

(21) Appl. No.: 18/600,438

(22) Filed: Mar. 8, 2024

(51) Int. Cl. G01S 13/32; G01J 1/42; G02B 3/00

(52) U.S. Cl. CPC G01S 13/32; G01J 1/4204; G02B 3/00

(57) ABSTRACT

Various arrangements of thermostats are detailed herein. A thermostat can include a housing, an electronic display, an ambient light sensor, and a lens assembly. The lens assembly can include a circular lens. The circular lens can include a first surface that is flat. A perimeter of the circular lens can be defined by a second surface that is perpendicular to the first surface of the circular lens. Third surface of the circular lens may be domed. The ambient light sensor can measure ambient light within an ambient environment of the thermostat through the domed circular lens.

### BACKGROUND

Thermostats tend to be highly visible products in persons' homes. Further, where heating and cooling wiring are installed can dictate where a thermostat is installed within a home. Thermostats are therefore required to be functional as well as aesthetically pleasing. Embodiments detailed herein can accomplish both of these goals.

### SUMMARY

Various embodiments are described related to a thermostat. In some embodiments, a thermostat is described. The thermostat may comprise a housing. The thermostat may comprise an electronic display housed by the housing. The thermostat may comprise an ambient light sensor housed by the housing. The thermostat may comprise a lens assembly attached with the housing. The lens assembly may comprise a circular lens. A first surface of the circular lens may be flat. A perimeter of the circular lens may be defined by a second surface that may be perpendicular to the first surface of the circular lens. A third surface of the circular lens may be domed. The ambient light sensor may measure ambient light within an ambient environment of the thermostat through the circular lens.

Embodiments of such a device may include one or more of the following features: a size of a field of view of the ambient light sensor may be increased by the third surface of the circular lens. The lens assembly may further comprise a polarized mirrored film attached with the circular lens. The polarized mirrored film may be oriented with respect to the electronic display to increase transmissivity of polarized light emitted by the electronic display. The lens assembly may further comprise a colored ink layer attached between the polarized mirrored film and the circular lens. The lens assembly may further comprise a masking layer attached between the polarized mirrored film and the electronic display. The lens assembly may further comprise one or more adhesive layers and only the one or more adhesive layers secure the lens assembly to the thermostat. The device may further comprise a radar sensor that emits radar signals and detects reflections of the radar signals through the lens assembly. The circular lens may comprise polymethyl methacrylate (PMMA). The circular lens may be formed using injection compression molding. The second surface of the circular lens may be completely surrounded by a rotatable ring.

In some embodiments, a method for manufacturing a thermostat lens assembly is described. The method may comprise creating a domed lens. A first surface of the circular lens may be flat. A perimeter of the circular lens may be defined by a second surface that may be perpendicular to the first surface of the circular lens. A third surface of the circular lens may be domed. The method may comprise measuring a direction of polarization of a mirror film. The method may comprise determining an orientation of the mirror film to attach with a lens assembly comprising the domed lens based on the measured direction of polarization of the mirror film. The method may comprise installing the lens assembly in a thermostat such that the determined orientation minimizes a polarizing effect on light emitted by an electronic display of the thermostat.

Embodiments of such a method may include one or more of the following features: the method may further comprise affixing a masking layer with the mirror film based on the determined orientation. The masking layer may be asymmetrical. The domed lens may be created using injection compression molding. The domed lens may be created from polymethyl methacrylate (PMMA). The method may further comprise affixing the circular lens to a colored ink layer using an optically clear adhesive. The method may further comprise affixing the mirrored film with the colored ink layer. The method may further comprise affixing one or more adhesive layers to the masking layer. Only the one or more adhesive layers may secure the lens assembly to the thermostat.

In some embodiments, a thermostat lens assembly comprising a circular lens is described. A first surface of the circular lens may be flat. A perimeter of the circular lens may be defined by a second surface that may be perpendicular to the first surface of the circular lens. A third surface of the circular lens may be domed. The device may further comprise a mirrored film layer having a polarization. The device may further comprise a masking layer that may be asymmetrical. The mirrored film may be oriented with respect to the masking layer based on the polarization. The device may further comprise an optically clear adhesive layer. The device may further comprise a colored ink layer. The optically clear adhesive layer may adhere the lens to the colored ink layer and the mirrored film layer may be in direct contact with the colored ink layer.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an embodiment of a smart thermostat system.

FIG. 2A is an isometric view of an embodiment of a smart thermostat.

FIG. 2B is a front view of an embodiment of a smart thermostat.

FIG. 2C is a side view of an embodiment of a smart thermostat.

FIG. 3A is an exploded front isometric view of an embodiment of a thermostat.

FIG. 3B is an exploded rear isometric view of an embodiment of a thermostat.

FIG. 4 is an exploded front isometric view of an embodiment of the layers of a domed lens assembly.

FIG. 5 is a cross section of an embodiment of a thermostat.

FIG. 6A illustrates a cross section of an embodiment of a lens assembly.

FIG. 6B illustrates a cross section of an embodiment of a lens assembly which alters the field of view of an ambient light sensor.

FIG. 7 illustrates an embodiment for manufacturing a domed lens assembly for a thermostat.

### DETAILED DESCRIPTION

A thermostat may have a domed lens that functions as part of a lens assembly. Since an electronic display may emit light through the domed lens and since the lens assembly may have a mirrored effect, any defects in the domed lens would be readily visible. In order to make the domed lens as defect-free as possible, injection compression molding can be used to manufacture the domed lens. In addition to being aesthetically pleasing, such a domed lens can help increase a field of view of one or more sensors, such as an ambient light sensor, that senses the environment through the lens assembly.

The lens assembly can include multiple layers to achieve desired visual effects. A domed lens can be attached with multiple layers including a colored ink layer, a mirror film layer, and/or a masking layer. The mirror film layer may be polarized. The orientation of polarization may need to be accounted for during manufacture to prevent excessive blocking of light emitted by an electronic display. To do so, the polarization of the mirror film layer may be determined such that the mirror film layer can be oriented with respect to the electronic display of the thermostat to maximize transmissivity of the mirror film layer for light emitted by the display.

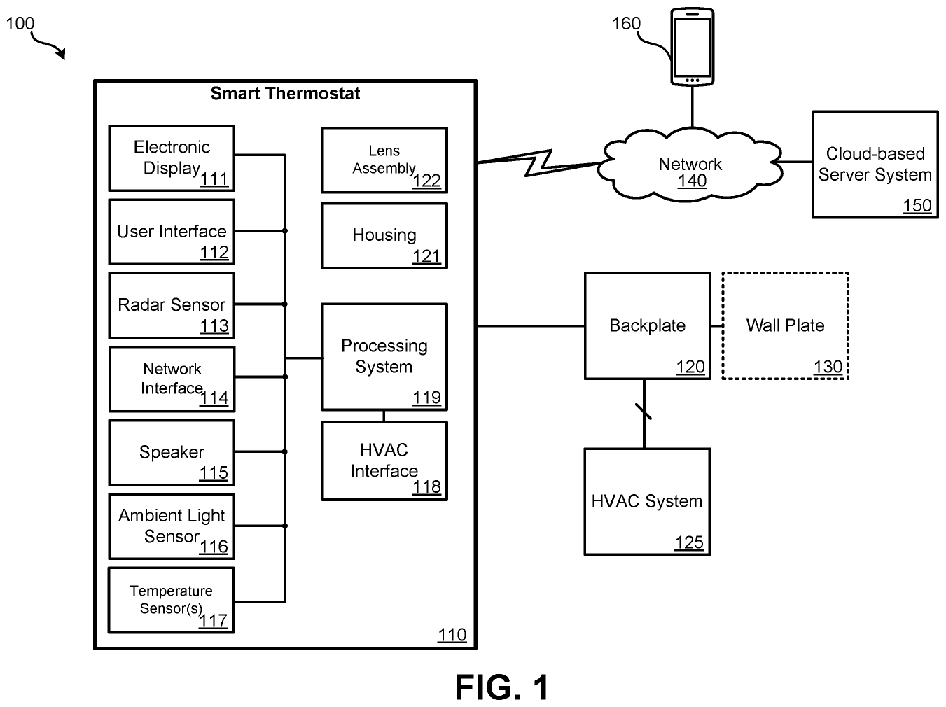

The figures and following description provide additional detail. FIG. 1 is a block diagram of an embodiment of a smart thermostat system. Smart thermostat system 100 can include smart thermostat 110; backplate 120; heating, ventilation, and air conditioning system (HVAC) 125; wall plate 130; network 140; cloud-based server system 150; and computerized device 160. Smart thermostat 110 represents embodiments of the thermostats detailed herein. Thermostat 110 can include: electronic display 111; user interface 112; radar sensor 113; network interface 114; speaker 115; ambient light sensor 116; one or more temperature sensors 117; HVAC interface 118; processing system 119; housing 121; and lens assembly 122.

Electronic display 111 may be visible through lens assembly 122. In some embodiments, electronic display 111 is only visible when electronic display 111 is at least partially illuminated. In some embodiments, electronic display 111 is a touch screen which can allow electronic display 111 to serve as a user interface to receive input. If a touch screen, electronic display 111 can allow one or more gestures, including tap and swipe gestures, to be detected.

User interface 112 can be various forms of input devices through which a user can provide input to smart thermostat 110. In some embodiments herein, an outer rotatable ring is present as part of user interface 112. The ring can be rotated by a user clockwise and counterclockwise in order to provide input. The ring can be infinitely rotatable in either direction, thus allowing a user to scroll or otherwise navigate user interface menus. The ring (and, possibly, lens assembly 122) can be pressed inward (toward the rear of smart thermostat 110) to function as a “click” or to make a selection. The outer rotatable ring can, for example, allow the user to make temperature target adjustments. By rotating the outer ring clockwise, the target temperature can be increased, and by rotating the outer ring counterclockwise, the target temperature can be decreased. As another example, the ring can be rotated to highlight displayed icons; an inward click can be provided by a user to select a particular icon.

Radar sensor 113 may be configured to output electromagnetic radiation into the ambient environment in front of electronic display 111 of thermostat 110. Radar sensor 113 may be an integrated circuit that includes one or more antennas, one or more RF emitters, and one or more RF receivers. Radar sensor 113 may be able to detect the presence of a user and the distance at which the user is located. Other details of a user may also be detected, such as velocity and whether the user is facing smart thermostat 110. Radar sensor 113 may use frequency-modulated continuous wave (FMCW) radar. Radar sensor 113 may emit electromagnetic radiation and receive reflected electromagnetic radiation through lens assembly 122. Radar sensor 113 may emit chirps of radar that sweep from a first frequency to a second frequency. Therefore, the waveform output by radar sensor 113 may be a sawtooth waveform. Using receive-side beam steering on the reflected radio waves received using multiple antennas, certain regions may be targeted for sensing the presence of users. For instance, beam steering away from the ground may be performed to avoid pets being potentially incorrectly detected as a user.

Network interface 114 may be used to communicate with one or more wired or wireless networks. Network interface 114 may communicate with a wireless local area network, such as a Wi-Fi network. Additional or alternative network interfaces may also be present. For example, smart thermostat 110 may be able to communicate with a user device directly, such as using Bluetooth or some other device-to-device short-range wireless communication protocol. Thermostat 110 may be able to communicate via a mesh network with various other home automation devices, such as using Thread. Mesh networks may use relatively less power compared to wireless local area network-based communication, such as Wi-Fi. In some embodiments, thermostat 110 can serve as an edge router that translates communications between a mesh network and a wireless local area network, such as a Wi-Fi network. In some embodiments, a wired network interface may be present, such as to allow communication with a local area network (LAN). One or more direct wireless communication interfaces may also be present, such as to enable direct communication with a remote temperature sensor installed in a different housing external and distinct from housing 121. The evolution of wireless communication to fifth generation (5G) and sixth generation (6G) standards and technologies provides greater throughput with lower latency which enhances mobile broadband services. 5G and 6G technologies also provide new classes of services, over control and data channels, for vehicular networking (V2X), fixed wireless broadband, and the Internet of Things (IoT). Thermostat 110 may include one or more wireless interfaces that can communicate using 5G and/or 6G networks.

Speaker 115 can be used to output audio. Speaker 115 may be used to output beeps, clicks, synthesized speech, or other audible sounds, such as in response to the detection of user input via user interface 112.

Ambient light sensor 116 may sense the amount of light present in the environment of thermostat 110. Measurements made by ambient light sensor 116 may be used to adjust the brightness of electronic display 111. In some embodiments, ambient light sensor 116 senses an amount of ambient light through lens assembly 122. Therefore, compensation for the reflectivity of lens assembly 122 may be made such that the ambient light levels are correctly determined via ambient light sensor 116. In some embodiments, a light pipe is present between ambient light sensor 116 and lens assembly 122 such that, in a particular region of lens assembly 122, light that is transmitted through lens assembly 122 is directed to ambient light sensor 116, which may be mounted to a printed circuit board (PCB), such as a PCB to which processing system 119 is attached.

One or more temperature sensors 117 may be present within thermostat 110. Temperature sensors 117 may be used to measure the ambient temperature in the environment of thermostat 110. One or more additional temperature sensors that are remote from thermostat 110 may additionally or alternatively be used to measure the temperature of the ambient environment.

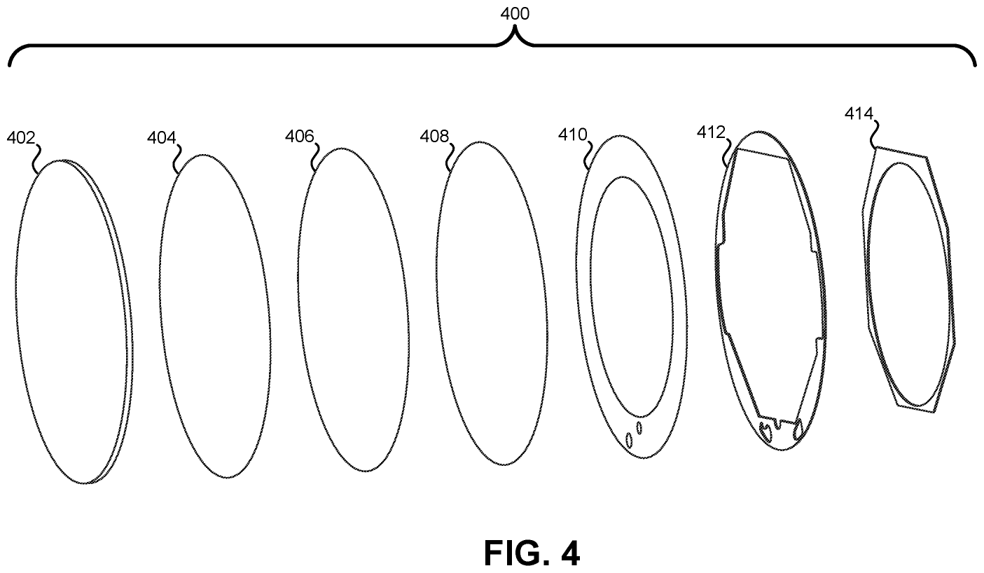

Lens assembly 122 may have a transmissivity sufficient to allow illuminated portions of electronic display 111 to be viewed through lens assembly 122 from an exterior of thermostat 110 by a user. Lens assembly 122 may have a reflectivity sufficient such that portions of lens assembly 122 that are not illuminated from behind appear to have a mirrored effect to a user viewing a front of thermostat 110. Further detail regarding lens assembly 122 are provided in relation to FIGS. 4-7.

HVAC interface 118 can include one or more interfaces that control whether a circuit involving various HVAC control wires that are connected either directly with thermostat 110 or with backplate 120 is completed. A heating system (e.g., furnace, boiler, heat pump), cooling system (e.g., air conditioner, heat pump), and/or fan may be controlled via HVAC wires by opening and closing circuits that include the HVAC control wires. In some installations, only a heating system or cooling system is controlled by smart thermostat 110; in other embodiments, smart thermostat 110 may control both a heating system and cooling system.

Processing system 119 can include one or more processors. Processing system 119 may include one or more special-purpose or general-purpose processors. Such special-purpose processors may include processors that are specifically designed to perform the functions detailed herein. Such special-purpose processors may be ASICs or FPGAs which are general-purpose components that are physically and electrically configured to perform the functions detailed herein. Such general-purpose processors may execute special-purpose software that is stored using one or more non-transitory processor-readable mediums, such as random access memory (RAM), flash memory, a hard disk drive (HDD), or a solid state drive (SSD) of thermostat 110.

Processing system 119 may output information for presentation to electronic display 111. Processing system 119 can receive information from temperature sensors 117, user interface 112, radar sensor 113, network interface 114, and ambient light sensor 116. Processing system 119 can perform bidirectional communication with network interface 114. Processing system 119 can output information to be output as sound to speaker 115. Processing system 119 can control the HVAC system via HVAC interface 118.

Housing 121 may house and/or attach with all of the components of smart thermostat 110, either directly or via other components. For example, lens assembly 122 may adhere to electronic display 111, which is attached with housing 121.

Thermostat 110 may be attached (and removed) from backplate 120. Some number of HVAC control wires may be attached with terminals or receptacles of backplate 120. Such HVAC control wires electrically connect backplate 120 with HVAC system 125, which can include a heating system, cooling system, ventilation system, or some combination thereof. Backplate 120 can allow smart thermostat 110 to be attached and removed from backplate 120 without affecting the electrical connections of the HVAC control wires with backplate 120. In other embodiments, such control wires are directly connected with smart thermostat 110. In some embodiments, wall plate 130 may additionally be installed between backplate 120 and a surface, such as a wall, such as for aesthetic reasons (e.g., cover an unsightly hole through which HVAC wires protrude from the wall.)

Network 140 can include one or more wireless networks, wired networks, public networks, private networks, and/or mesh networks. A home wireless local area network (e.g., a Wi-Fi network) may be part of network 140. Network 140 can include the Internet. Network 140 can include a mesh network, which may include one or more other smart home devices, may be used to enable thermostat 110 to communicate with another network, such as a Wi-Fi network. Thermostat 110 may function as an edge router that translates communications from a relatively low power mesh network received from other devices to another form of network, such as a relatively higher power network, such as a Wi-Fi network.

Cloud-based server system 150 can maintain an account mapped to smart thermostat 110. Thermostat 110 may periodically or intermittently communicate with cloud-based server system 150 to determine whether setpoint or schedule changes have been made. A user may interact with thermostat 110 via computerized device 160, which may be a mobile device, smartphone, tablet computer, laptop computer, desktop computer, or some other form of computerized device that can communicate with cloud-based server system 150 via network 140 or can communicate directly with thermostat 110 (e.g., via Bluetooth or some other device-to-device communication protocol). A user can interact with an application executed on computerized device 160 to control or interact with thermostat 110.

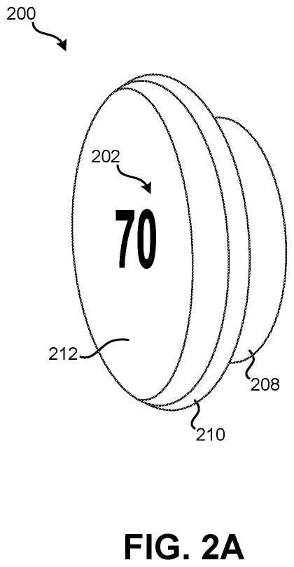

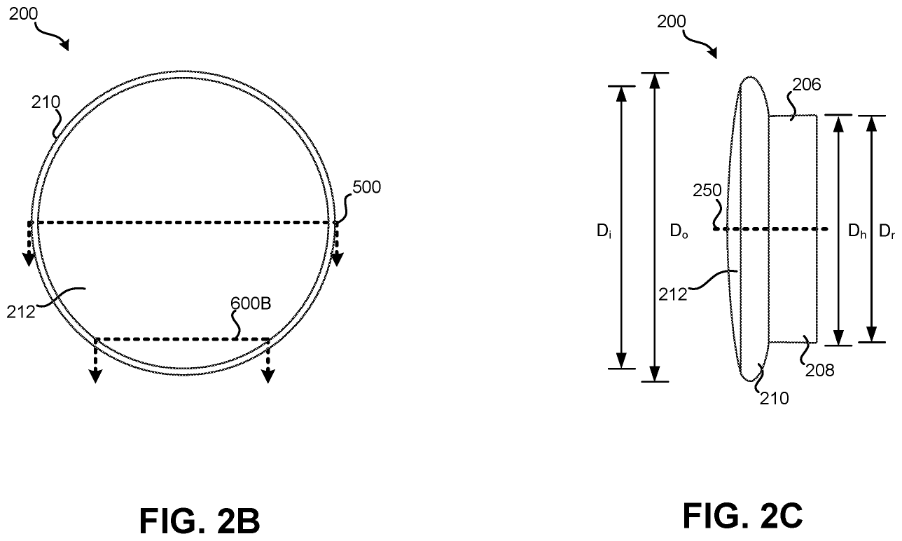

FIG. 2A is an isometric view of an embodiment of a smart thermostat 200. Smart thermostat 200 can represent an embodiment of smart thermostat 110 of FIG. 1. In FIG. 2A, electronic display 202, located behind lens assembly 212, is active in displaying a setpoint temperature. The housing of smart thermostat 200 can define sidewall 208. Sidewall 208 may be generally cylindrical according to various embodiments. A diameter of the sidewall 208 may be smaller than a diameter of the electronic display 202 and ring 210 according to various embodiments and as illustrated in FIG. 2A. Ring 210 can function as detailed in relation to user interface 112. Either attached with housing 121 or attached with components connected with housing 121 is lens assembly 212. Lens assembly 212 may include a reflective layer having a reflectivity such that when the electronic display 202 is not illuminated, lens assembly 212 appears to be a mirror when viewed by a user.

In some embodiments, ring 210 is mounted to lens assembly 212. In other embodiments, ring 210 can be rotated clockwise and counterclockwise independent of lens assembly 212. In some embodiments, housing 121 includes a display frame (not visible in this view) that further supports electronic display 202 and lens assembly 212.

Electronic display 202 is housed behind lens assembly 212 such that, when illuminated, the portion of electronic display 202 that is illuminated is visible through lens assembly 212 by a user. In some embodiments, due to the reflectivity of lens assembly 212, an edge of electronic display 202 is not visible to a user regardless of whether electronic display 202 is illuminated, partially illuminated, or not illuminated. Therefore, the overall effect experienced by a user may be that lens assembly 212 appears as a mirror and portions of electronic display 202, when illuminated, are visible through lens assembly 212.

In various embodiments, around an axis perpendicular to the display face of electronic display 202, the ring 210 has an inner diameter and an outer diameter and both the inner diameter and the outer diameter of ring 210 are larger than a diameter of sidewall 208 of housing 121.

FIG. 2B is a front view of an embodiment of smart thermostat 200. When mounted on a wall or other surface, lens assembly 212 is opposite the portion of smart thermostat 200 that mounts to the wall or other surface. Therefore, when a user is facing mounted smart thermostat 200, lens assembly 212 is visible. Lens assembly 212 can form an uninterrupted circular surface with no gaps, holes, lens, or other discontinuities present on the outermost surface of lens assembly 212. Lens assembly 212 has sufficient transmissivity to allow light emitted by electronic display 202 located within housing 206 to be visible through lens assembly 212. Further, lens assembly 212 may have sufficient reflectivity such that a mirrored effect is present on portions of lens assembly 212 that are not currently being illuminated from behind by electronic display 202.

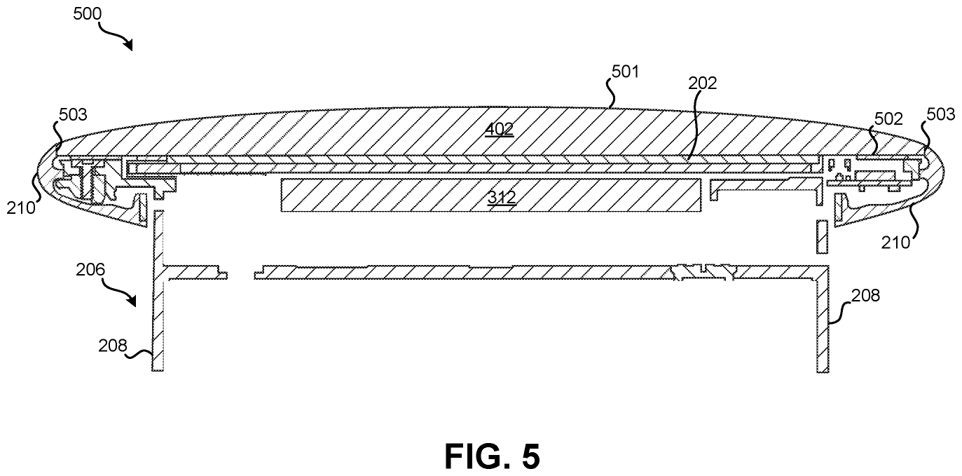

Present in FIG. 2B is an indication of cross-section 500. Cross-section 500 is detailed in relation to FIG. 5.

FIG. 2C is a side view of an embodiment of a smart thermostat. When smart thermostat 200 is mounted to a wall or other surface, sidewall 208 of housing 121 is visible. Around an axis 250, the ring 210 has an inner diameter Di and an outer diameter Do and both the inner diameter Di and the outer diameter Do of the ring 210 are larger than a diameter Dh of sidewall 208 of housing 121. According to various embodiments, sidewall 208 of housing 121 can be generally cylindrical and can have a consistent diameter along a length thereof. Alternatively, a diameter of sidewall 208 can increase as a distance from lens assembly 212 increase.

In some embodiments, ring 210 has a smallest diameter at the rearmost portion of ring 210. Dr is indicative of the diameter of ring 210 where ring 210 meets sidewall 208. This arrangement can help facilitate a user's fingers reaching around ring 210, grasping ring 210, and rotating in either direction. In some embodiments, along axis 250, sidewall 208 may have a diameter of approximately Dr wherein ring 210 and sidewall 208 meet. In some embodiments, the diameter of sidewall 208 can increase as the distance from ring 210 increases.

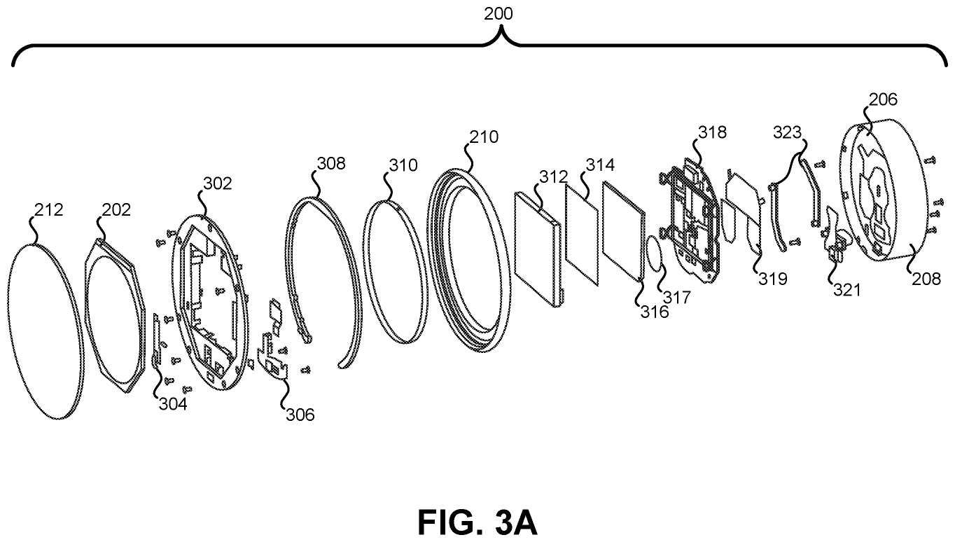

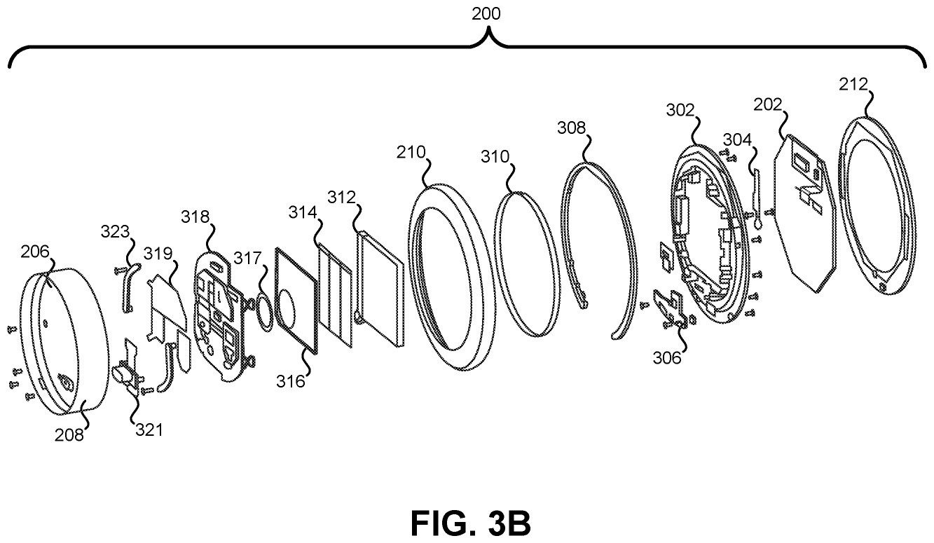

FIG. 3A is an exploded front isometric view of an embodiment of smart thermostat 200. FIG. 3B is an exploded rear isometric view of smart thermostat 200. Viewing the components of the smart thermostat 200 left to right, lens assembly 212 forms an outermost domed surface of smart thermostat 200. Adjacent lens assembly 212 may be electronic display 202. Electronic display 202 may be a liquid-crystal display (LCD) or organic light emitting diode (OLED) display according to various embodiments. In at least some embodiments, one or more adhesives may be used to attach electronic display 202 with lens assembly 212. An exploded view of lens assembly 212 is provided in relation to FIG. 4.

According to at least some embodiments, electronic display 202 is supported by a display frame 302. Smart thermostat 200 further includes one or more antenna assemblies 304 for communicating with a network and/or other electronic devices. Antenna assembly 304 can be used for communicating with wireless local area networks (e.g., Wi-Fi), device-to-device communication (e.g., Bluetooth), and/or communicating with mesh networks (e.g., Thread). Smart thermostat 200 includes one or more sensor boards, such as sensor daughterboard 306. One or more temperature sensors may be installed on sensor daughterboard 306. Use of sensor daughterboard 306 can help isolate the one or more temperature sensors from heat generated by other components.

Smart thermostat 200 may further include clip 308 for coupling ring 210 and display frame 302 supporting electronic display 202. Clip 308 may act as an axial constraint for smart thermostat 200. In particular, clip 308 prevents electronic display 202, display frame 302, and ring 210 from decoupling from one another in the assembled configuration.

As shown in FIG. 3A, smart thermostat can include magnetic strip 310. According to various embodiments, ring 210 rotates relative to sidewall 208 of housing 206 and a backplate when smart thermostat 200 is mounted to a surface. In various embodiments, a sensor installed on a sensor board, such as sensor board 306 and magnetic strip 310 are used for detecting rotation of the ring 210 during use.

According to various embodiments, ring 210 is mounted to housing 206 such that ring 210 can be rotated clockwise and counterclockwise. Ring 210 may include polished stainless steel and a finish applied using physical vapor deposition (PVD). Ring 210 further advantageously provides an aesthetic appearance as the finish of the ring 210 appears seamless relative to lens assembly 212 having a mirrored effect.

Further internal components of smart thermostat 200 include battery 312 and battery adhesive 314. Battery 312 can be a secondary battery and can provide power to the various components of smart thermostat 200, including electronic display 202 and processing system 119. Battery adhesive 314 may be used to adhere battery 312 within housing 206 although the battery 312 (or any other components of the smart thermostat 200) may be secured within the housing 206 using other means. For example, various components may be secured using adhesives, screws, wires, clips, or the like.

Smart thermostat 200 includes processing system 316. According to some embodiments, processing system 316 is a system-on-a-chip (SoC) including various processing parts, memory, modems, etc. Processing system 316 may be in electric communication with one or more antennas present on antenna assembly 304, sensor board 306, electronic display 202, etc., for performing various functions of the smart thermostat 200 and outputting results based on user input (e.g., in response to the user rotating the ring 210 and/or user input via an external mobile device). Adjacent processing system 316 may be piezo sensor 317. Additional components of the processing system 316 or components that work with processing system 316 are also shown in FIG. 3. For example, multi-layer board (MLB) 318 may be provided for performing various functions of smart thermostat 200, in a manner that would be appreciated by one having ordinary skill in the art. In some embodiments, MLB 318 may include a Universal Serial Bus (USB) port for electrically coupling smart thermostat 200 to another electronic device for various updates, servicing, or the like. Various springs 319 for supporting components, flexes 321 for enabling flexible and high-density interconnects between printed circuit boards (PCBs), LCDs, etc., and additional links 323 may also be included in the internal components of smart thermostat 200.

Smart thermostat 200 may include more or fewer components than those shown in FIG. 3A and FIG. 3B. In various embodiments, the components may be in one or more configurations other than the configuration shown in FIG. 3A. Advantageously, various components of smart thermostat 200 are optimized to be condensed into housing 206 such that the overall side profile of smart thermostat 200 is significantly thinner than a side profile of other commercially available smart thermostats.

FIG. 4 is an exploded front view of various embodiments of lens assembly 400. Lens assembly 400 can represent embodiments of lens assembly 122 and 212. In particular, FIG. 4 illustrates an embodiment of a stack of components that can be used to create lens assembly 122. Lens assembly 400 can include: domed lens 402; optically clear adhesive (OCA) layer 404; tinted ink layer 406; mirror film 408; masking layer 410; frame pressure sensitive adhesive (PSA) 412; and display PSA 414. While embodiments of lens assembly 400 may be used on smart thermostat 200, embodiments of such a lens assembly may be used on other forms of smart devices. For instance, lens assembly 400 can be incorporated as part of a smart assistant device or a smart watch.

Domed lens 402 may be domed on an outer surface and flat on an inner surface that is in contact with OCA layer 404. Further detail regarding the shape of domed lens 402 is provided in reference to FIG. 5. Domed lens 402 can be formed from polymethyl methacrylate (PMMA), which can provide a transparency similar to glass. Other plastic or acrylic materials are also possible. Domed lens 402 may also be formed from glass. Domed lens 402 can be formed using injection compression molding. Injection compression molding can be used because it allows for defect-free surfaces to be formed. To perform injection compression molding of domed lens 402, material can be injected into a nearly closed mold. The mold may then be compressed such that the injected material conforms to the shape of the mold. Excess material can be removed, such as through machining.

Domed lens 402 is circular and does not have any holes, vents, gaps, or other discontinuities present on it. Similarly, no holes, vents, gaps, or other discontinuities are present on at least OCA layer 404, tinted ink layer 406, and mirror film layer 408. Having continuous material helps to maintain a consistent visual effect across the entirety of lens assembly 400 as viewed by a user.

OCA layer 404 can be a pressure or temperature sensitive adhesive that adheres domed lens 402 with tinted ink layer 406. Tinted ink layer 406 can be a transparent layer that tints light passing through tinted ink layer 406. Since tinted ink layer 406 is closer to domed lens 402 than mirror film layer 408, both light by mirror film layer 408 and light emitted by electronic display 111 is tinted. The color used for tinting can be selected based on aesthetics.

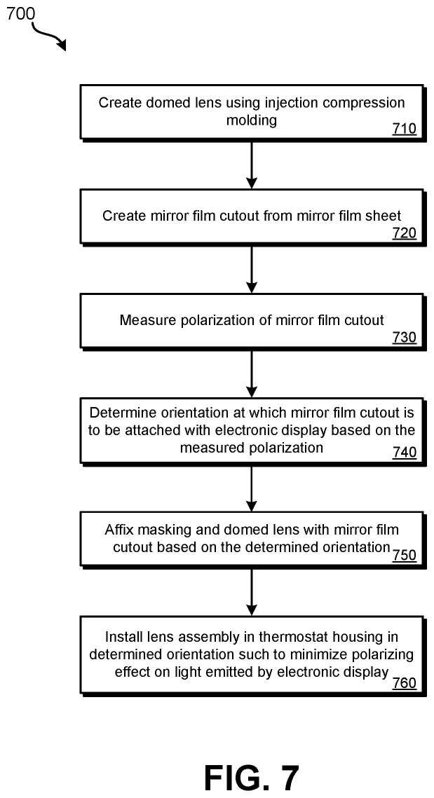

Mirror film layer 408 may have sufficient reflectivity that when electronic display 111 is not illuminated, a user viewing lens assembly 400 may see a reflection of himself, herself, or the ambient environment. For example, mirror film layer 408 can be Toray® 125FH-40 mirror film. Mirror film layer 408 may be polarized. Due to the way some mirror films are manufactured, throughout a roll of mirror film, the direction of polarization can vary. When a piece of mirror film is stamped or cut out to form mirror film layer 408, the direction of polarization may be determined in order to orient in relation the electronic display, which also outputs polarized light. If orientation is not controlled, visibility of the electronic display through mirror film layer 408 may be adversely affected. Further detail regarding orientation of mirror film layer 408 is detailed in relation to FIG. 7.

Masking layer 410 can be used to block a user from viewing components blocked by the opaque portions of masking layer 410. Masking layer 410 may be black or another dark color to make it difficult to see through mirror film layer 408. Masking layer 410 can obscure a view of frame adhesive 414 and display adhesive 416. Masking layer 410 may be asymmetric. Therefore, it must be oriented in a particular orientation with respect to other components of smart thermostat 200. For example, masking layer 410 includes a hole for an ambient light sensor to have a field of view of the ambient environment through domed lens layer 402, OCA layer 404, tinted link layer 406, and mirror film layer 408.

Furthermore, the masking layer 410 may help enhance the effect that the electronic display is seamless with lens assembly 400. A color value for masking layer 410 may be selected, having an appropriate lightness value, such that it is difficult or impossible for a user to visually see an edge of the electronic display screen within the smart device. By obscuring an edge of the edge of the electronic display, a user may have the impression that the entire region behind domed lens 402 is electronic display 111.

Obscured behind masking layer 410 may be two separate adhesive layers. Frame adhesive layer 412 may adhere domed lens layer 402, OCA layer 404, tinted link layer 406, mirror film layer 408, and masking layer 410 to display frame 302. Display adhesive layer 414 may adhere domed lens layer 402, OCA layer 404, tinted link layer 406, mirror film layer 408, and masking layer 410 to electronic display 202. Different types of adhesives may be used to provide better adhesion to the material of electronic display 202 and display frame 302. Adhesive layer 412 and display adhesive layer 414 may both be different types of pressure sensitive adhesives (PSAs). In other embodiments, a single adhesive layer may be used. For example, 3M® 5126-025 may be used as the PSA.

FIG. 5 is a cross section 500 of an embodiment of smart thermostat 200. The location and direction of cross section 500 is indicated on FIG. 2B. The domed profile of domed lens 402 is visible in the cross section of FIG. 5. Surface 501 is the outer surface of domed lens 402 that is adjacent the ambient environment and which a user can touch. An entirety of surface 501 is convex from edge to edge. Surface 502 is the inner surface and adheres with OCA layer 404. OCA layer 404 and other layers of lens assembly 400 are not visible in FIG. 5. An entirety of surface 502 can be flat. Surface 503 forms a circumference around the entirety of domed lens 402. Surface 503 is perpendicular or approximately perpendicular (defined as within 5° of perpendicular) to surface 502.

Electronic display 202 is disposed under the domed lens 402 and surrounded by rotatable ring 510. In particular, ring 210 surrounds surface 503 of domed lens 402 and couples to housing 206, which has a cylindrical sidewall 208.

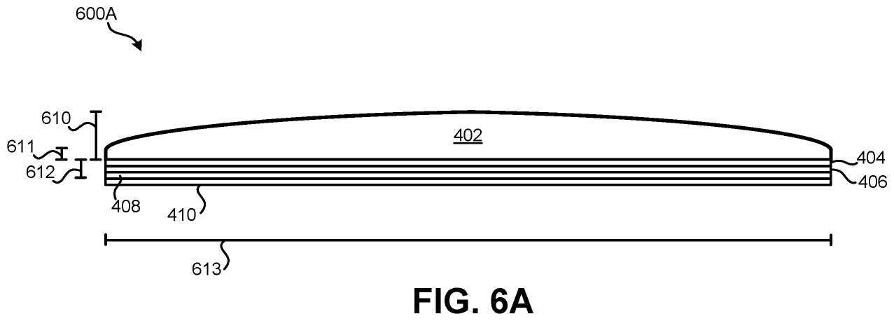

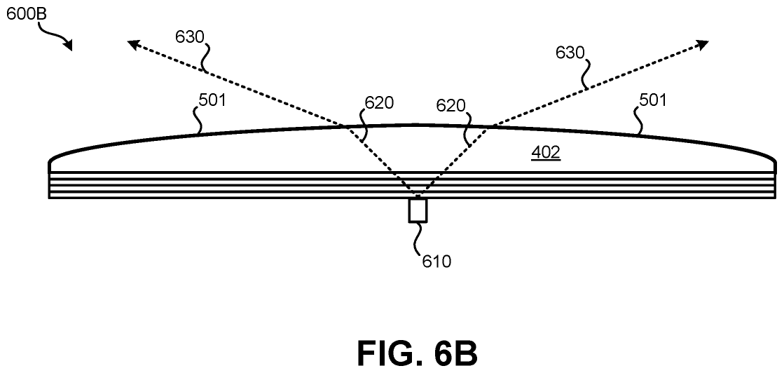

FIG. 6A illustrates a cross section 600A of an embodiment of lens assembly 212. Cross section 600A of FIG. 6A is not to scale. Cross section 600A represents a cross section at the same location as cross section 500, but only including lens assembly 212. Domed lens 402 has center thickness 610. Center thickness 610 can be between 3 and 8 mm thick. In some embodiments, center thickness 610 is between 5 and 6 mm thick, such as 5.47 mm. Edge thickness 611 represents the thickness of domed lens 402 around the entirety of its circumference. Edge thickness 611 can be between 1 and 2 mm, such as 1.3 mm. Film thickness 612 can represent the total thickness of OCA layer 404, tinted ink layer 406, and mirror film layer 408. Film thickness 612 can be between 0.1 mm and 0.2 mm. In some embodiments, film thickness 612 is 0.17 mm. Lens assembly 212 can have a diameter 613 of between 75-120 mm. In some embodiments, lens assembly 212 has diameter 613 of between 90-100 mm. As a specific example, diameter 613 can be 93.2 mm.

FIG. 6B illustrates a cross section 600B of an embodiment of lens assembly 212. Cross section 600B of FIG. 6B is not to scale. Cross section 600B is indicated in FIG. 2B. Cross section 600B only represents lens assembly 212. Ambient light sensor 610 has field-of-view 620. The domed shape of domed lens 402 causes field-of-view 620 to be expanded to field-of-view 630 at surface 501. This increase in the angle of field-of-view 630 compared with field-of-view 620 is caused at least in part by the domed shape of domed lens 402. This same effect can make the electronic display of the smart thermostat 200 visible at a greater angle to a user. This effect can be particularly useful where a user may be approaching smart thermostat 200 from the side, such as when smart thermostat 200 is mounted to a wall of a hallway.

In order to create the embodiments of lens assembly 122, 212, and 400 detailed herein, a method of manufacturing can be performed. FIG. 7 illustrates an embodiment of a method 700 for manufacturing lens assemblies as detailed herein, such as for installation in a smart thermostat or other smart device. Specifically, method 700 allows for the polarization of the mirror film layer of the lens assembly to be accounted for during manufacture to ensure that light emitted from an electronic display of the smart thermostat or smart device is not blocked. Light emitted from such an electronic display can have a particular polarization and if the mirror film's polarization is normal to the polarization of the electronic display, all or a significant portion of emitted light can be blocked by the mirror film.

At block 710, injection compression molding can be used to form the domed lens. In injection compression molding, a liquified material, such as PMMA, can be injected into a mold that has not been completely closed. Following the material being injected or while the material is being injected, the mold may be completely closed. Excess material may be squeezed out of the mold where the two halves of the mold meet. This additional material may be removed, such as via a machining process. The resulting domed lens may be defect-free or nearly defect-free having highly smooth surfaces.

Mirror film may be acquired in the form of a roll of film material. Throughout the roll, polarization of the mirror film may vary. For example, at a beginning of a mirror film roll, polarization may be close to vertical, but may transition to near horizontal further into the roll. Therefore, if the polarization direction is not determined, significant variability can result from installing a mirror film in relation to an electronic display. At block 720, cutouts, such as circular cutouts, of mirror film can be made from a mirror film sheet, which can be in the form of a mirror film roll.

At block 730, for each mirror film cutout, the direction of polarization can be determined. In some embodiments, this can be accomplished by shining polarized light at the mirror film cutout and determining an orientation that either maximizes obstruction or minimizes obstruction of the light.

At block 740, based on the measured polarization of block 730, an orientation at which the mirror film cutout is to be installed in relation to the electronic display is determined. The direction of polarization of the light emitted by the electronic display is known; therefore, the mirror film's orientation is adjusted to account for the known polarization of the electronic display. At some stage in the manufacturing process, the mirror film cutout is adhered to the domed lens along with any intervening layers. Since these layers may be symmetrical (e.g., circular with no holes or discontinuities), the orientation of the mirror film cutout may not matter. In some embodiments, the colored ink layer is applied to the mirror film. The OCA layer is then attached to the ink/mirror film, after which the OCA/ink/mirror film may be attached with the domed lens. The masking layer may be asymmetric, such as due to a cutout for an ambient light sensor; therefore, orientation of the mirror film with respect to the masking layer needs to take into account the polarization. At block 750, the masking layer is affixed with the mirrored film cutout using the determined orientation. Block 750 can be performed before or after the mirror film layer has been affixed to the domed lens (and any intervening layers). Following block 750, the domed lens, mirror film cutout, and masking layer and possibly other layers now form a lens assembly, such as lens assembly 400. Additionally, one or more adhesive layers (e.g., adhesive layer 412 and adhesive layer 414) may be added to the lens assembly for use in attaching the lens assembly to the smart thermostat or smart device.

At block 760, the lens assembly is installed in the smart thermostat or smart device housing according to the determined orientation to minimize the polarizing effect of the mirror film on light emitted by the electronic display. For example, if the light emitted by the electronic display is vertically polarized, the orientation of the mirror film in the lens assembly allows for transmission of vertically polarized light. In the context of block 760, “minimize” can mean approximately keep to a minimum, such as block less than 5%, 10%, or 20% of the emitted light of the electronic display due to the polarizing effect of the mirror film cutout.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A thermostat, comprising:
a housing;
an electronic display housed by the housing;
an ambient light sensor housed by the housing;
a lens assembly attached with the housing, the lens assembly comprising:
a circular lens, wherein:
a first surface of the circular lens is flat;
a perimeter of the circular lens is defined by a second surface that is perpendicular to the first surface of the circular lens;
a third surface of the circular lens is domed; and
the ambient light sensor measures ambient light within an ambient environment of the thermostat through the circular lens.

2. The thermostat of claim 1, wherein a size of a field of view of the ambient light sensor is increased by the third surface of the circular lens.

3. The thermostat of claim 1, wherein the lens assembly further comprises a polarized mirrored film attached with the circular lens.

4. The thermostat of claim 3, wherein the polarized mirrored film is oriented with respect to the electronic display to increase transmissivity of polarized light emitted by the electronic display.

5. The thermostat of claim 4, wherein the lens assembly further comprises a colored ink layer attached between the polarized mirrored film and the circular lens.

6. The thermostat of claim 5, wherein the lens assembly further comprises a masking layer attached between the polarized mirrored film and the electronic display.

7. The thermostat of claim 5, wherein the lens assembly further comprises one or more adhesive layers and only the one or more adhesive layers secure the lens assembly to the thermostat.

8. The thermostat of claim 2, further comprising a radar sensor that emits radar signals and detects reflections of the radar signals through the lens assembly.

9. The thermostat of claim 8, wherein the circular lens comprises polymethyl methacrylate (PMMA).

10. The thermostat of claim 9, wherein the circular lens is formed using injection compression molding.

11. The thermostat of claim 10, wherein the second surface of the circular lens is completely surrounded by a rotatable ring.

12. A method for manufacturing a thermostat lens assembly, the method comprising:
creating a domed lens, wherein:
a first surface of the circular lens is flat;
a perimeter of the circular lens is defined by a second surface that is perpendicular to the first surface of the circular lens; and
a third surface of the circular lens is domed;
measuring a direction of polarization of a mirror film;
determining an orientation of the mirror film to attach with a lens assembly comprising the domed lens based on the measured direction of polarization of the mirror film; and
installing the lens assembly in a thermostat such that the determined orientation minimizes a polarizing effect on light emitted by an electronic display of the thermostat.

13. The method for manufacturing the thermostat lens assembly of claim 12, further comprising affixing a masking layer with the mirror film based on the determined orientation, wherein the masking layer is asymmetrical.

14. The method of claim 12, wherein the domed lens is created using injection compression molding.

15. The method of claim 14, wherein the domed lens is created from polymethyl methacrylate (PMMA).

16. The method for manufacturing the thermostat lens assembly of claim 13, further comprising:
affixing the circular lens to a colored ink layer using an optically clear adhesive; and
affixing the mirrored film with the colored ink layer.

17. The method for manufacturing the thermostat lens assembly of claim 16, further comprising:
affixing one or more adhesive layers to the masking layer, wherein only the one or more adhesive layers secure the lens assembly to the thermostat.

18. A thermostat lens assembly, comprising:
a circular lens, wherein:
a first surface of the circular lens is flat;
a perimeter of the circular lens is defined by a second surface that is perpendicular to the first surface of the circular lens; and
a third surface of the circular lens is domed.

19. The thermostat lens assembly of claim 18, further comprising:
a mirrored film layer having a polarization; and
a masking layer that is asymmetrical, wherein the mirrored film is oriented with respect to the masking layer based on the polarization.

20. The thermostat lens assembly of claim 19, further comprising:
an optically clear adhesive layer; and
a colored ink layer, wherein the optically clear adhesive layer adheres the lens to the colored ink layer and the mirrored film layer is in direct contact with the colored ink layer.
